(19) United States
(12) Patent Application Publication
(10) Pub. No.: US 2010/0123650 A1
(43) Pub. Date: May 20, 2010

(54) Portable Electronic Device

(76) Inventors: Tzu-Ming WANG, Hsinchu City (TW); Yi-Ching Wang, Hsinchu City (TW); Ted-Hong Shinn, Hsinchu City (TW)

Correspondence Address: HDLS Patent & Trademark Services, P.O. BOX 220746, CHANTILLY, VA, 20153-0746, US

(21) Appl. No.: 12/344,468

(22) Filed: Dec. 27, 2008

(30) Foreign Application Priority Data
Nov. 18, 2008 (TW) 097144593

(51) Int. Cl. G09G 3/30

(52) U.S. Cl. 345/76

(57) ABSTRACT

A portable electronic device used for connecting to a remote server includes an identification module, a signal transceiver module, an electro-phoretic display (EPD) and a power supply module. The signal transceiver module is used for transmitting an identified data received by the identification module to the remote server and receiving a data signal from the remote server. The EPD is used for displaying the data signal received by the signal transceiver module. The power supply module is electrically connected to the identification module, the signal transceiver module and the EPD for supplying power to them. The portable electronic device may connect to different financial locations according to user choices, so the latest financial information of user may be provided by the portable electronic device.

### BACKGROUND

1. Field of the Invention

The invention is related to an electronic device, and more particular, to a portable electronic device for providing users the latest financial information immediately.

1. Description of the Related Art

Nowadays everything is particular about convenience and efficiency. The plastic currencies, for instance, debit card, credit card, cash card, value-added card, stocks debenture and so on, and the value notes gradually replace the cash that is commonly used before. Therefore, the various booklets are relatively increasing, such as the bankbooks, the bills of credit cards and the stock securities passbooks etc.

However, those paper books are inconvenient for carrying, arranging and reading, and consumers have to waste time on going to the financial locations for recording or changing the booklets. Besides, the consumers can not receive the latest financial information through those paper books.

### BRIEF SUMMARY

Accordingly, the present invention is to provide a portable electronic device which may connect to a remote server for receiving the latest financial information of user.

The present invention provides a portable electronic device used for connecting to a remote server. The portable electronic device comprises an identification module, a signal transceiver module, an electro-phoretic display (EPD) and a power supply module. The identification module is used for receiving an identified data and the signal transceiver module is used for transmitting the identified data received by the identification module to the remote server and receiving a data signal from the remote server. The electro-phoretic display is electrically connected to the signal transceiver module for displaying the data signal received by the signal transceiver module. The power supply module is electrically connected to the identification module, the signal transceiver module and the electro-phoretic display.

In an embodiment according to this invention, the portable electronic device further comprises an inputting module providing users to input the identified data.

In an embodiment according to this invention, the electro-phoretic display comprises a monochrome display region and a color display region. For example, the electro-phoretic display comprises an active elements array substrate, an electro-phoretic layer, a transparent substrate and a color photoresist layer. The electro-phoretic layer is disposed on the active elements array substrate. The transparent substrate is disposed above the active elements array substrate. The color photoresist layer is disposed on a portion of the transparent substrate and located between the electro-phoretic layer and the transparent substrate.

In an embodiment according to this invention, the portable electronic device further comprises a waterproof layer and the electro-phoretic display has a display surface and a back surface opposite to each other. The waterproof layer covers the display surface and the back surface of the electro-phoretic display.

In an embodiment according to this invention, the electro-phoretic layer may be a microcup electro-phoretic layer or a microcapsule electro-phoretic layer.

In an embodiment according to this invention, the power supply module comprises an optical energy storage unit used for storing optical energy and a photoelectric transducer unit used for transforming the optical energy stored by the optical energy storage unit into electric energy.

In an embodiment according to this invention, the portable electronic device further comprises a light source disposed beside at least one side of the electro-phoretic display.

In an embodiment according to this invention, the light source may be light emitting diodes, organic light emitting diodes or cold-cathode-fluorescent lamps.

In an embodiment according to this invention, the portable electronic device further comprises a display controlling module electrically connected to the electro-phoretic display in order to control the images displayed by the electro-phoretic display.

The portable electronic device of this invention may connect to different financial locations according to user choices, so the latest financial information of user may be provided by the portable electronic device immediately. Furthermore, the portable electronic device of this invention displays information by the electro-phoretic display which has the qualities of flexibility, being without backlight sources, low power consumption, frame memorizing, unlimited viewing-angle, fast responding speed and high contrast. Hence, the portable electronic device with high display quality may be provided.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a circuit block diagram of the portable electronic device according to an embodiment of the present invention.

FIG. 2 is a front view of the portable electronic device according to an embodiment of the present invention.

FIG. 3A is a schematic view of the electro-phoretic display of the portable electronic device according to an embodiment of the present invention.

FIG. 3B is a schematic view of the electro-phoretic display of the portable electronic device according to another embodiment of the present invention.

FIG. 4 is a circuit block diagram of the portable electronic device according to another embodiment of the present invention.

FIG. 5 is a back view of the portable electronic device according to another embodiment of the present invention.

FIG. 6 is a schematic view of the portable electronic device according to another embodiment of the present invention.

FIG. 7 is a front view of the portable electronic device according to another embodiment of the present invention.

FIG. 8 is a circuit block diagram of the portable electronic device according to another embodiment of the present invention.

FIG. 9 is a front view of the portable electronic device according to another embodiment of the present invention.

### DETAILED DESCRIPTION

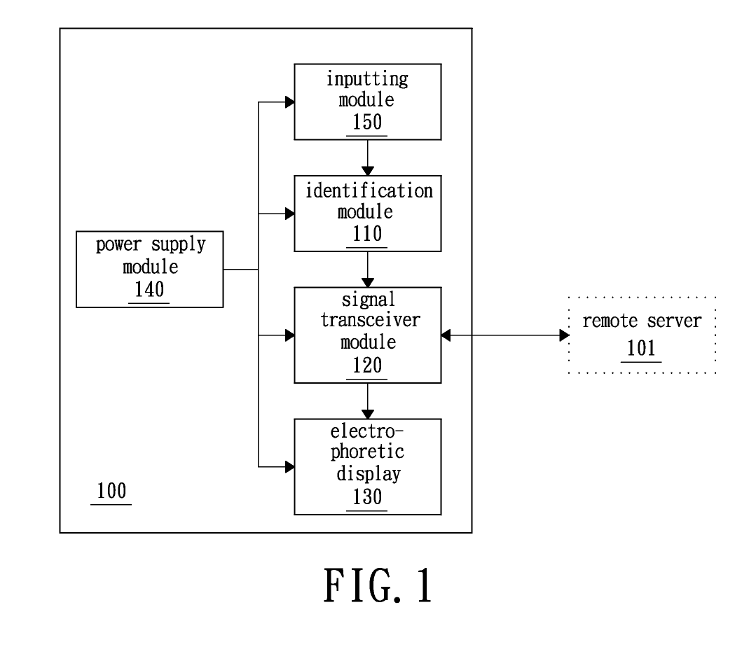

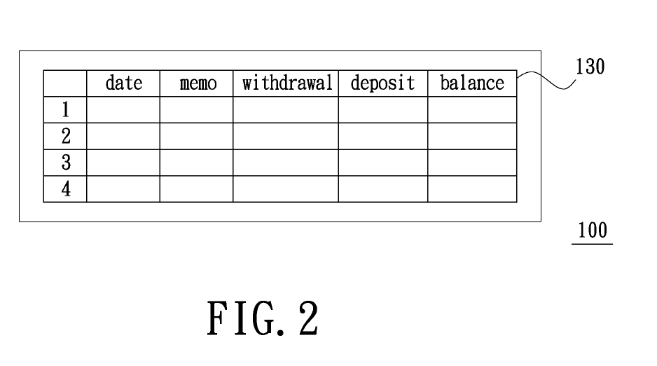

FIG. 1 is a circuit block diagram of the portable electronic device according to an embodiment of the present invention. FIG. 2 is a front view of the portable electronic device according to an embodiment of the present invention. Referring to FIG. 1 and FIG. 2, the portable electronic device 100 is used for connecting to a remote server 101 in order to exchange data. The remote server 101, for example, belongs to financial locations but not limited to a specified financial location. In other words, the portable electronic device of the present invention may connect to different remote server according to user's choices.

Referring to FIG. 1, the portable electronic device 100 comprises an identification module 110, a signal transceiver module 120, an electro-phoretic display 130 and a power supply module 140. The identification module 110 is used for receiving identified data inputted by users. The identification data may be personalized identified data, such as account/password, barcode, fingerprints, palm prints, voice, the face images or digital signature. Accordingly, the identification module 110 may be a barcode identification machine, a fingerprints/palm prints identification system, a voice identification system or a face images identification system.

As described above, the user inputs the identified data to the identification module 110 through the inputting module 150 in an embodiment of the present invention. In specific, the inputting module 150 may be a user input device such as a keyboard, a mouse, a handwriting panel or a voice/image capturing device or a transmission interface used for connected to the user input device such as a universal serial bus. Thus, users can input the identified data through these user input devices or connect the portable electronic device 100 to a storage medium(such as a flash drive not shown) in order to transmit the identified data stored in the storage medium to the portable electronic device 100.

Referring to FIG. 1 again, the signal transceiver module 120 is used for transmitting the identification data received by the identification module 110 to the remote server 101 and then receiving a data signal from the remote server 101. Specifically, the data signal received by the signal transceiver module 120 is the financial information of user such as the transaction details of the depositor, the deposit/loan information or the bills of the credit cards. In addition, the signal transceiver module 120 may be a wireless/cable network, a radio wave transceiver, an infrared radiation transceiver or a bluetooth transceiver.

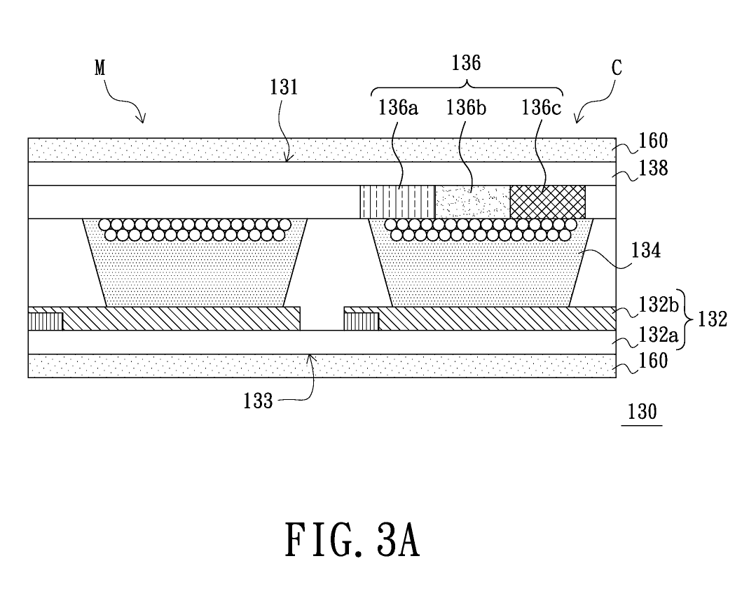

FIG. 3A is a schematic view of the electro-phoretic display of the portable electronic device according to an embodiment of the present invention. Referring to FIG. 1 and FIG. 3A, the electro-phoretic display 130 is used for displaying the data signal received by the signal transceiver module 120. The electro-phoretic display 130 may be a monochrome display device or a color display device. In this embodiment, the electro-phoretic display 130 has a color display region C used for displaying chromatic images and a monochrome display region M used for displaying black and white images.

In detail, the electro-phoretic display 130 of this embodiment comprises an active element array substrate 132, an electro-phoretic layer 134, a color photoresist layer 136 and a transparent substrate 138. The active element array substrate comprises a substrate 132a and an active element array 132b. The material of the substrate 132a is, for example, metal, glass or flexible plastic materials such as polyethylene terephathalate (PET), polyethylene naphthenate, polyaramid, polyimide, polycycloolefin, polysulfone (PSF), epoxy, polycarbonate or polymethyl methacrylate (PMMA).

As described above, the electro-phoretic layer 134 disposed on the active element array substrate 132 may be a microcup electro-phoretic layer shown in FIG. 3A or a microcapsule electro-phoretic layer shown in FIG. 3B. The transparent substrate 138 is disposed above the electro-phoretic layer 134. The material of the transparent substrate is, for example, glass, PET, polyethylene naphthenate, polyaramid, polyimide, polycycloolefin, PSF, epoxy, polycarbonate, PMMA or other flexible plastic materials.

The color photoresist layer 136 is disposed on a portion of the transparent substrate 138 and located between the electro-phoretic layer134 and transparent substrate 138. In detail, the color photoresist layer 136 comprises monochrome photoresist layers 136a, 136b and 136c, which are, for example, red, green and blue photoresist layers respectively. Therefore, the region where the color photoresist layer 136 disposed in is the color display region C of the electro-phoretic display 130. On the other hand, the region where the color photoresist layer 136 not disposed in is the monochrome display region M of the electro-phoretic display 130.

Accordingly, since the color photoresist layer 136 is disposed on a portion of the transparent substrate 138 in this embodiment, the rate of the color photoresist layer 136 of shielding the reflected light of the electro-phoretic display 130 may be decreased. Therefore, the chromatic electro-phoretic display having high brightness may be provided.

In addition, the electro-phoretic display 130 comprises a display surface 131 and a back surface 133 opposite to each other. In specific, the display surface 131 is a surface of the transparent substrate 138, and the back surface 133 is a surface of the active elements array substrate 132. Furthermore, a waterproof layer 160 is covered on the display surface 131 and the back surface 133 in this embodiment to prevent the inside circuit of the electro-phoretic display from being damaged by the mist permeated from outside. The material of the waterproof layer 160 is, for example, a multilayer film made of rubber, resin, transparent PET and silicon oxidation or of transparent PET and aluminum oxidation.

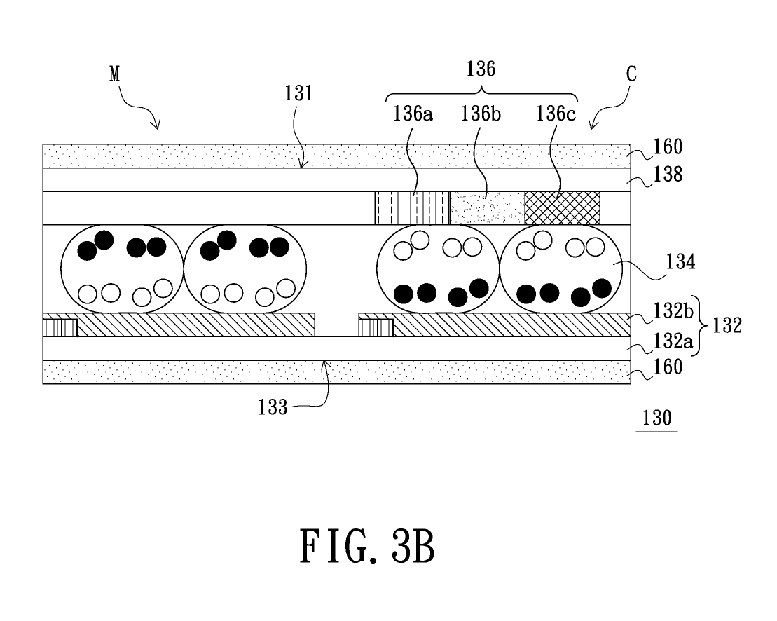

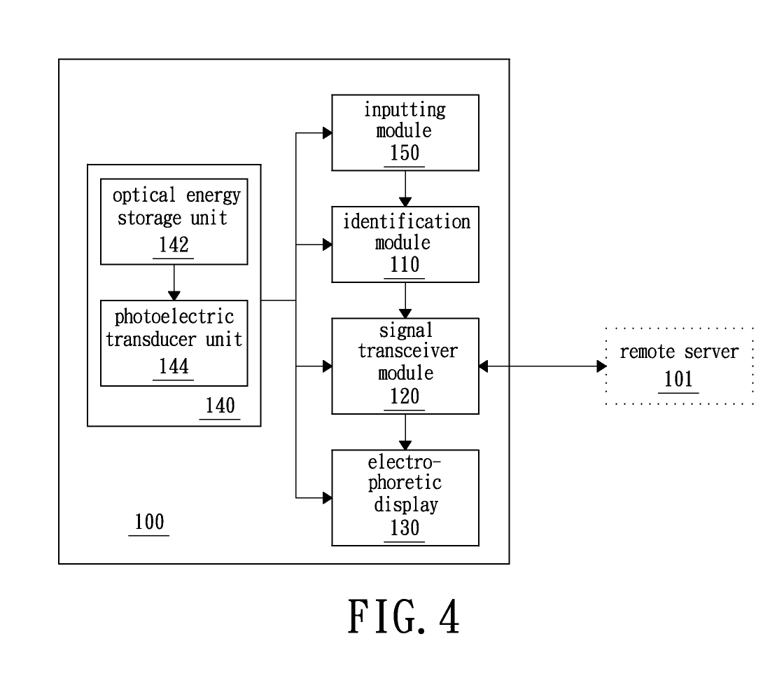

The power supply module 140 is electrically connected to the identification module 110, the signal transceiver module 120 and the electro-phoretic display 130 for supplying power to them. In this embodiment, the power supply module 140 comprises an optical energy storage unit 142 and a photoelectric transducer unit 144 shown in FIG. 4. The optical energy storage unit 142 is used for storing the optical energy received from sun and the photoelectric transducer unit 144 is used for transforming optical energy into electric energy to supply power to the identification module 110, the signal transceiver module 120 and the electro-phoretic display 130. Specifically, the power supply module 140 in this embodiment is a solar battery attached to the back of the electro-phoretic display 130, as shown in FIG. 5.

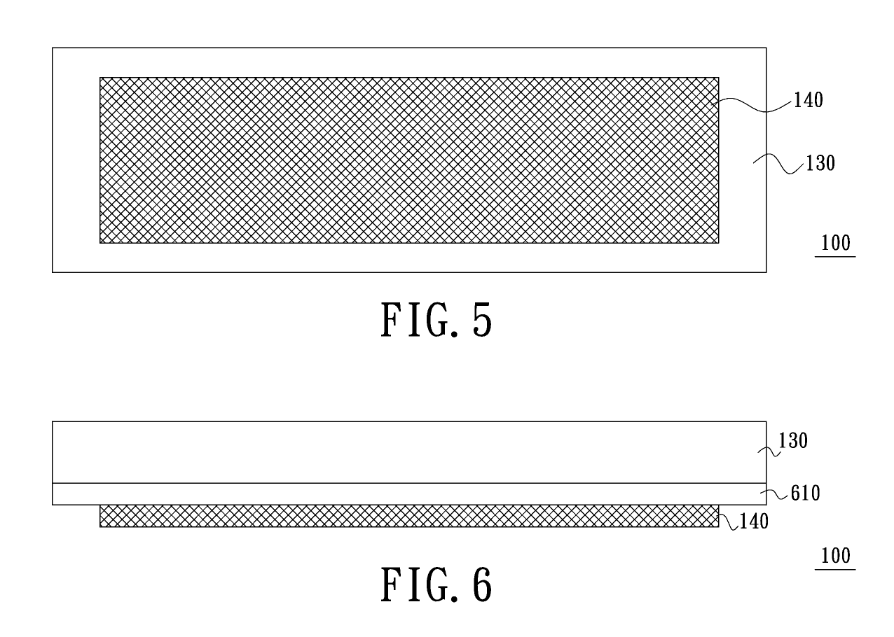

In addition, the identification module 110 and the signal transceiver module 120 may be disposed on a driving circuit board 610, as shown in FIG. 6. The driving circuit board 610 may be attached between the power supply module 140 and the electro-phoretic display 130 and is electrically connected to the power supply module 140 and the electro-phoretic display 130.

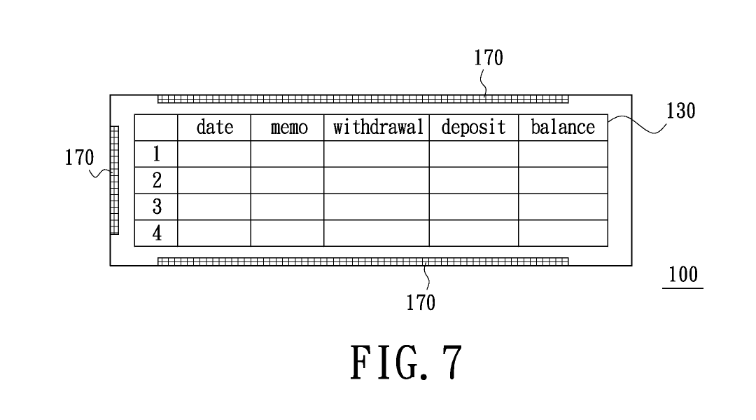

Particularly, the portable electronic device of this invention further comprises a light source 170 disposed beside at least one side of the electro-phoretic display 130, as shown in FIG. 7. The light source 170 is used for providing light to the electro-phoretic display for displaying in a situation that the brightness of an ambient light is not enough. The light source may be light emitting diodes, organic light emitting diodes or cold-cathode-fluorescent lamps.

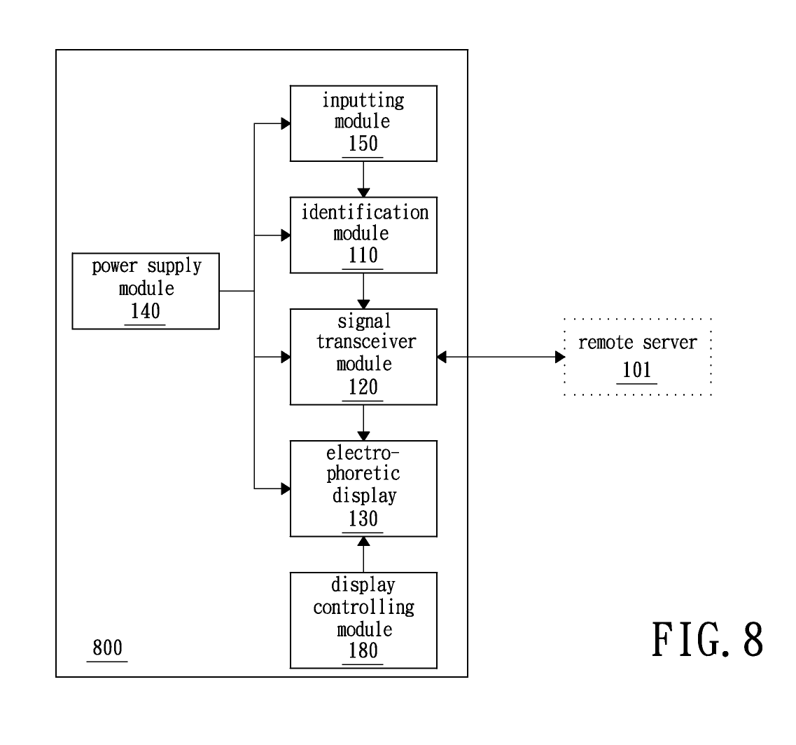

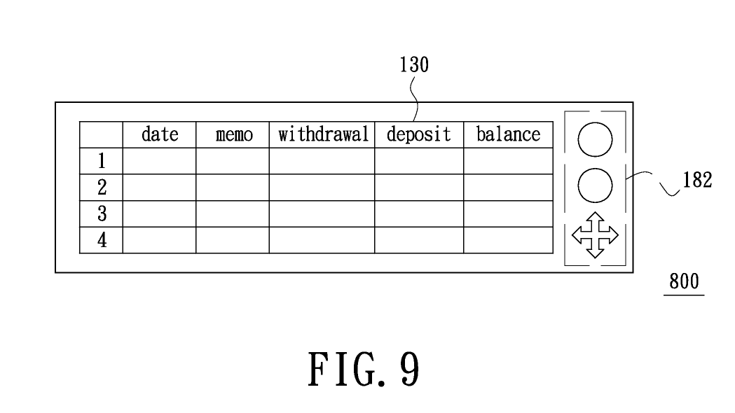

FIG. 8 is a circuit block diagram of the portable electronic device according to another embodiment of the present invention. FIG. 9 is a front view of the portable electronic device according to another embodiment of the present invention. Referring to FIG. 8 and FIG. 9, the difference between this embodiment and the above-mentioned embodiment is the portable electronic device 800 further comprises a display controlling module 180 used for controlling the frame displayed by the electro-phoretic display 130 to move, for example, upward, downward, leftward and rightward or change pages. Specifically, the display controlling module 180 comprises at least a function button 182 used for controlling the frame displayed by the electro-phoretic display 130.

In summary, the portable electronic device of this invention may connect to different financial locations according to user choices, so the latest financial information of user may be provided through the portable electronic device. Furthermore, the users may receive their financial information from the financial locations after inputting the identified data without going to the financial locations to enter or change bankbooks. As a result, the portable electronic device of this invention is more convenient than the paper bankbooks in prior art.

In addition, since the portable electronic device of this invention displays information by the electro-phoretic display which has the qualities of flexibility, being without backlight sources, low power consumption, frame memorizing, unlimited viewing-angle, fast responding speed and high contrast, so it is not only light and thin for easily to carry, but also provided with improved quality of displaying.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A portable electronic device used for connecting to a remote server, comprising:
an identification module used for receiving an identified data;
a signal transceiver module used for transmitting the identified data to the remote server and receiving a data signal from the remote server;
an electro-phoretic display electrically connected to the signal transceiver module in order to display the data signal; and
a power supply module electrically connected to the identification module, the signal transceiver module and the electro-phoretic display.

2. The portable electronic device as recited in claim 1, further comprising an inputting module, wherein a user inputs the identified data through the inputting module.

3. The portable electronic device as recited in claim 1, wherein the electro-phoretic display has a monochrome display region and a color display region.

4. The portable electronic device as recited in claim 3, wherein the electro-phoretic display comprising:
an active element array substrate;
an electro-phoretic layer disposed on the active elements array substrate;
a transparent substrate disposed above the active elements array substrate; and
a color photoresist layer disposed on a portion of the transparent substrate and located between the electro-phoretic layer and the transparent substrate.

5. The portable electronic device as recited in claim 1, wherein the electro-phoretic layer is a microcup electro-phoretic layer or a microcapsule electro-phoretic layer.

6. The portable electronic device as recited in claim 1, further comprising a waterproof layer, the electro-phoretic display has a display surface and a back surface opposite to each other, and the waterproof layer covers the display surface and back surface of the electro-phoretic display.

7. The portable electronic device as recited in claim 1, wherein the power supply module comprising:
an optical energy storage unit used for storing an optical energy; and
a photoelectric transducer unit used for transforming the optical energy to electric energy.

8. The portable electronic device as recited in claim 1, further comprising a light source disposed beside at least one side of the electro-phoretic display.

9. The portable electronic device as recited in claim 8, wherein the light source is light emitting diodes, organic light emitting diodes or cold cathode fluorescent lamps.

10. The portable electronic device as recited in claim 1, further comprising a display controlling module electrically connected to the electro-phoretic display in order to control frames displayed by the electro-phoretic display.
